(19) United States
(12) Patent Application Publication
(10) Pub. No.: US 2012/0230550 A1
(43) Pub. Date: Sep. 13, 2012

(54) Method and Apparatus for Generating a Map from Landmarks

(76) Inventor: Jacob Kraut, Winnipeg (CA)

(21) Appl. No.: 13/044,557

(22) Filed: Mar. 10, 2011

(51) Int. Cl. G06K 9/00

(52) U.S. Cl. 382/113

(57) ABSTRACT

A method and apparatus for generating a map from landmarks. The method and apparatus may involve the use of a processor circuit. An embodiment may consist of a platform with a processor circuit, and various different sensors for landmark generation that are known to the art such as a plurality of cameras and/or laser rangefinders. Landmarks are stored in a data structure with their past untransformed landmarks. New landmark data is matched using previous stored untransformed landmarks. Generally current position is only used for matching when backtracking or closing the loop. Landmarks are grouped with other landmarks that are visible in the same time interval. In these groups, dynamic landmarks are identified computationally efficiently using binning. Using basis landmarks in a group, a map relative to these basis landmarks is generated that is translation and rotation invariant. These relative maps are linked together to form a global map. Current position is non cumulative and generated by comparing currently observed landmarks to their global positions. The advantages of this method and apparatus is that it is computationally real time, has dynamic landmark detection and has comparable accuracy to other methods known in the art.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to generating a map of an environment given inaccurate and possibility dynamic landmark data obtained from a plurality of sensors.

2. Prior Art

Mobile robots are currently being developed to perform autonomous tasks. To allow a mobile robot to navigate autonomously in an environment, the robot requires accurate position and map data. Some environments the robot has accurate position data from a GPS and a previously generated map. In these environments, autonomous navigation is simple.

In other environments the robot only has sensor information such as camera data, laser rangefinders, and odometry data. Since a map is not available, it can be difficult to generate accurate position data. Since accurate position data is not available, it can be difficult to generate an accurate map. This problem is referred to Simultaneous Localization and Mapping (SLAM).

There are many solutions to the SLAM problem. Most of them use a probabilistic approach. The location of the robot is probabilistically determined and this is used to place landmark data computed from sensors into a map. There are two main disadvantages to these techniques. One is that the computation time increases with the number of objects on the map. This makes it difficult for the robot to operate autonomously in real time. The other is that these techniques cannot handle dynamic objects. If there are objects that are moving in the environment these techniques are known to get lost.

In addition to the SLAM problem using a moving platform, the method and apparatus for generating a map from landmarks can also work on a stationary platform. In this case the map is not used for navigation, rather it is used to identify dynamic features and, track them. In this patent, the output of both the moving and stationary platforms are referred to as a map.

3. Objects and Advantages

The advantages of the present method and apparatus for generating a map from landmarks are that it is able to operate in real time and it can identify dynamic features of an environment. The method and apparatus has comparable accuracy to the known previous techniques such as the Extended Kalman Filter (see Dissanayake et al, A computationally Efficient Solution to the Simultaneous Localisation and Map Building (SLAM) problem, Proceedings of the 2000 IEEE international Conference on Robotics & Automation (ICRA) April 2000, pp. 1009-1014.) and FastSLAM (see Montemerlo et al FastSLAM: A Factored Solution to the Simultaneous Localization and Mapping Problem, Proceedings of the American Association for Artificial Intelligence, Edmonton, Canada (2002)).

The present method and apparatus is not affected by increasing the total quantity of landmarks on the map. Rather, it is only affected by the average quantity of landmarks that are visible at any time. This is a large advantage compared to the other algorithms. When mapping large areas, the total number of landmarks increases while the average quantity of visible landmarks may not. Also the other known techniques cannot handle dynamic landmarks in real time without losing accuracy. Dynamic landmarks are landmarks that their movement is not correlated with the movement of the viewpoint. An example of a stationary landmark is a window. An example of a dynamic landmark is a person moving in a hallway.

### SUMMARY OF THE INVENTION

Embodiments of the invention use sensor data in the form of landmarks to generate a map of the environment. The map can contain dynamic landmarks that are identified and tracked. The landmarks can consists of points, planes, textured surfaces, etc. . . . The landmarks can be generated by various methods such as computer vision, or laser rangefinders. The only requirement of a landmark is that it is possible to identify the same landmark from one viewing iteration to the next.

One of the main principles of the invention is that landmarks are stored in a structure with all or many of their past untransformed observations. The untransformed observation contains the initial location as seen by the viewpoint without being transformed into a different coordinates such as global coordinates. The untransformed landmarks are used to match subsequent observations of the same landmark avoiding the use of current position for matching. Most other techniques use current position to match landmarks. If there is a large enough error in current position those techniques fails.

Landmarks that are observed together in the same time interval are placed into groups. In these groups, the relative locations of landmarks are computed. The stored untransformed observations for each landmark are used to do the computation. For each iteration before any comparisons can occur, the untransformed landmarks are transformed with a matrix for rotation and translation invariance. A transform matrix is used to move a group of locations from one place to another.

Rotation and translation invariance is required since as the viewpoint moves the absolute coordinates of landmarks will change but their relative coordinates to each other will not. To maintain the invariance, it is required to use one or several of the landmarks as a basis. The relative coordinates are calculated from the basis landmark(s). The difference of a landmark's location from the basis landmark(s) is consistent regardless of the robot's viewpoint. The difference of the relative location for each landmark can be averaged using many stored untransformed observations to obtain the accurate relative locations of a group of landmarks.

To form a map from the relative locations of many groups, each group's relative map is combined. This is accomplished by generating a transform matrix from landmarks that are present in more than one group. To align the map to the actual map, the observations seen at the first iteration are assumed to place the robot at the starting position.

Notice that there is no mention of current position so far. In this algorithm, current position is not used as a state variable that is updated cumulatively. Instead it is computed by comparing the current observations of landmarks to the global map that is generated. Other than display purposes, current position is only used when a landmark that is already present on the map has not been successfully matched to the last few iterations untransformed observation's. This occurs when backtracking or closing the loop.

If required it is possible to use past current position data to predict and filter the current position. It is also possible to use odometry, positional data obtained by GPS, or closing the loop recognition to aid the mapping process by correcting errors.

When the initial untransformed matching fails, a landmark is transformed to global coordinates using the current position and then it can be compared to the global map. If this still fails to find a match then it is assumed to be a new landmark. In a sense, all the global matching is doing, is using the previously known relative relationship between landmarks compared to the last iteration's observations. When closing a loop, global matching is dependent on the overall accuracy of the map. However backtracking is local and is invariant to global mapping error.

If dynamic points are not identified they will cause map errors. It is possible to identify dynamic points by comparing every point against each other. Points with low standard deviation can be placed into groups and the largest group can be considered the static one. However doing it this way would be computationally unfeasible given a large number of points. This is due to the computation scaling O(n²).

Instead after a sufficient quantity of iterations, dynamic detection can be used that is much faster. Pair wise comparisons can be made using the stored untransformed observations. Landmark pairs with low standard deviation can be binned together. An approximation can be made, that only one landmark per bin needs to be compared against another bin. Two heuristics are used: if one bin has the majority number of landmarks the algorithm can be stopped, and to prioritize bins with past positive comparisons. The dynamic detection algorithm is O(n log n), even if a high percentage of points are dynamic.

The speed of the dynamic detection comes from the ability to use the stored untransformed observations. During the dynamic detection it becomes evident which landmarks are being grouped together. As the bin size increases this reduced the number of comparisons required. The stored untransformed observations allow the comparisons to happen in a delayed fashion after it is better known which landmarks are static. It is possible to perform the dynamic detection for a group of landmarks in one iteration, or amortize the dynamic detection over many iterations.

The invention is shown to have comparable accuracy compared to other currently used methods. In general, its execution time is faster and it can operate in environments with dynamic features where the other techniques cannot.

### BRIEF DESCRIPTION OF THE DRAWINGS

These and other features of the invention will now be described with references to the drawings summarized below.

These drawings (not to scale) and the associated descriptions are provided to illustrate preferred embodiments of the invention and are not intended to limit the scope of the invention.

FIG. 1A, 1B, 1C illustrates examples of a map generating robot.

FIG. 2A, 2B, 2C illustrates examples of a stationary apparatus for tracking dynamic movement.

FIG. 3 is a block diagram of a computer system shown in FIGS. 1A, 1B, 1C, 2A, 2B and 2C.

FIG. 4 is a flow chart of a process for generating a map executed by a processor shown in FIG. 3.

FIG. 5 is a flow chart of a process executed by the processor shown in FIG. 3 for processing a single iteration of landmark observations sensor as first described in FIG. 4.

FIG. 6 is a flow chart of a process executed by the processor shown in FIG. 3, for initializing data structures at the start of an iteration, as first described in FIG. 5.

FIG. 7 is a flow chart of a process executed by the processor shown in FIG. 3, for registering an observation of a landmark to landmarks already present on the map, as first described in FIG. 5.

FIG. 8 is a flow chart of a process executed by the processor shown in FIG. 3, for creating a group for ungrouped landmarks, as first described in FIG. 5.

FIG. 9 is a flow chart of a process executed by the processor shown in FIG. 3, for performing dynamic landmark identification, as first described in FIG. 8.

FIG. 10 is a flow chart of a process executed by the processor shown in FIG. 3, for generating a map for every group and linking those groups together into a global map as first described in FIG. 5.

FIG. 11 is a flow chart of a process executed by the processor shown in FIG. 3, for linking groups together into a global map, as first described in FIG. 10.

### DETAILED DESCRIPTION

Although this invention will be described in terms of certain preferred embodiments, other embodiments that are apparent to those of ordinary skill in the art, including embodiments that do not provide all of the benefits and features set forth herein, are also within the scope of this invention.

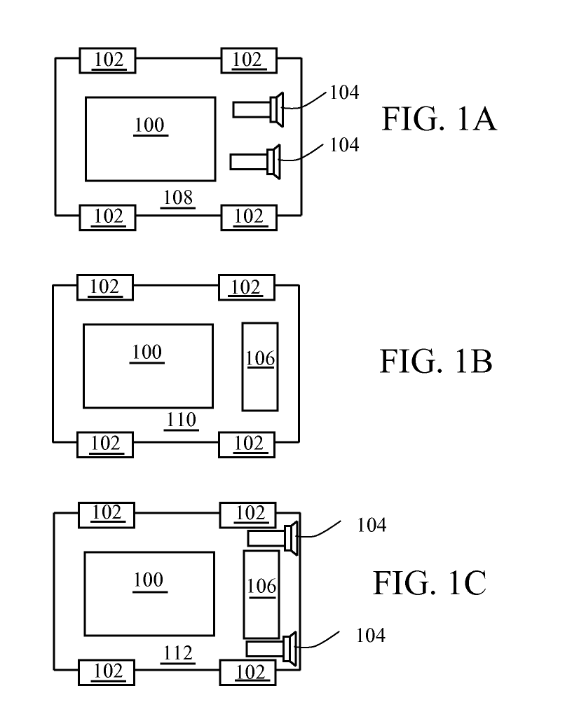

Referring to FIG. 1A, an apparatus for generating a map is shown generally in a platform 108. The apparatus includes a computer shown generally at 100 operable to receive digital images from a plurality of cameras 104. The apparatus contains a means of locomotion 102 consisting of a plurality of actuators. This embodiment is generally referred to as a mobile robot.

Effectively, the computer 100 is programmed to generate landmarks from the images produced by the plurality of cameras 104. The landmarks are stored untransformed as generated from the current viewpoint. These landmarks are then used to generate a representation of a dynamic environment.

Referring to FIG. 1B, and FIG. 1C other embodiments 110 and 112 are similar to the embodiment of 108 with the difference being the sensor used to generate the landmarks. The embodiment 110 includes a laser rangefinder 106 that sends data to the computer 100. The data is processed by the computer 100 to generate landmarks. The embodiment 112 has a combination of laser rangefinder 106 and a plurality of cameras 104 that sends data to the computer 100. The data is processed by the computer 100 to generate landmarks.

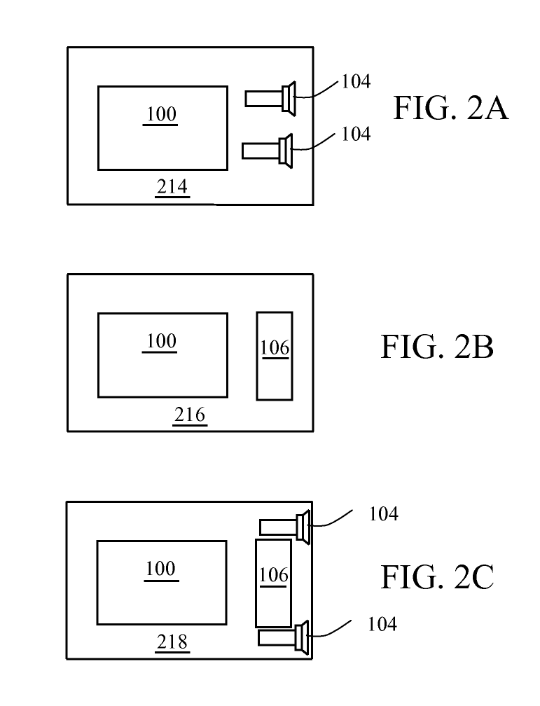

Referring to FIG. 2A, FIG. 2B, and FIG. 2C, other embodiments are 214, 216, and 218. These embodiments include a computer 100, a combinations of sensors which data is used to generate landmark: a plurality of cameras 104, and laser rangefinders 106. The embodiments of 214, 216, and 218 do not contain actuators for locomotion and are stationary. The embodiments of 214, 216, and 218 are used to generate a map of an area. This map consists of identifying static landmarks and dynamic landmarks. The dynamic landmarks that are identified are tracked as they move.

Other embodiments that are apparent to those of ordinary skill in the art consist of different sensors, different techniques to obtain landmarks from sensors, a plurality of computers, and various actuators for locomotion.

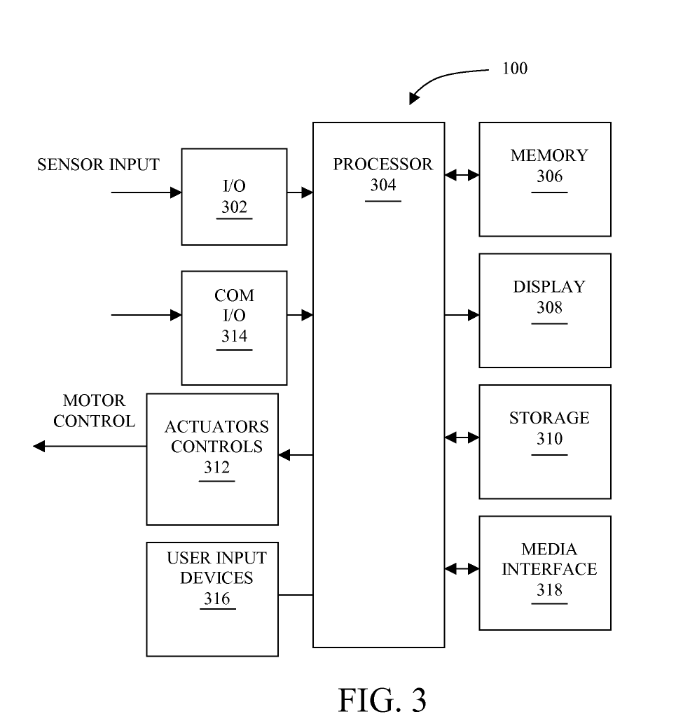

Referring to FIG. 3, the computer 100 is shown in greater detail and includes a processor circuit. In this embodiment, the processor circuit includes a processor 304 and an I/O port 302 for receiving sensor data from a plurality of cameras 104, and/or rangefinders 106, and/or other embodiments of to obtain landmark data. The processor circuit also includes a data store. The data store may include a persistent storage medium such as a hard drive or flash drive 310. The data store may also include a dynamic storage medium such as RAM 306. The RAM holds programs for directing the processor 304, to receive sensor data from the I/O port 302 and store the data in either the RAM 306 or persistent storage 310. In addition, in some embodiments the processor 304 may be connected to a display unit 308 and user input 316 such as a keyboard or the like. The processor 304 may be connected to a communications I/O port 314 for connection to a modem and ultimately the internet. Also the processor 304 may be in communications with a media interface 318 such as a CD ROM drive or a floppy diskette drive.

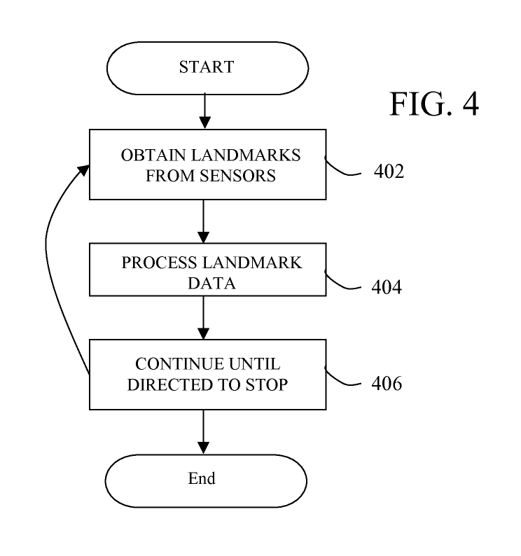

Referring to FIG. 4, a process for generating a map from landmarks is carried out by the processor 100 shown in FIG. 3. Block 402 obtains landmark data from the sensor. Block 402 may obtain the landmarks by a simple data transfer from the sensors or may require additional data processing from the sensor data to generate the landmarks. One embodiment of the sensor and landmark data may be the plurality of cameras 104 using SIFT features. The concept of SIFT has been extensively described in the literature. See David G. Lowe, Local Feature View Clustering for 3D Object Recognition, Proceedings of the IEEE Conference on Computer Vision and Pattern Recognition, Kauai, Hi. (December 2001).

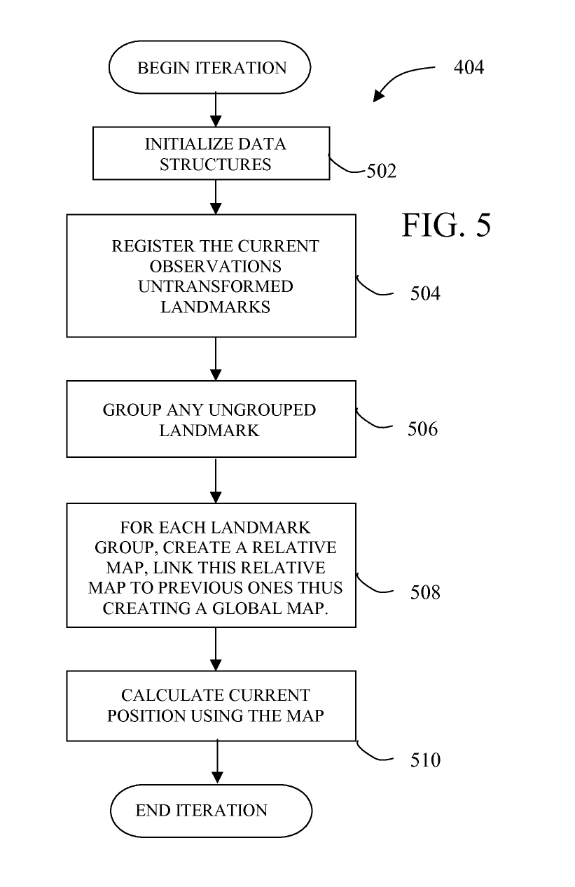

Referring to FIG. 4, the processor is directed to execute block 404 which processes the landmark data into a map. Block 404 is described in detail in FIG. 5. The process continues of obtaining sensor data 402 and processing the data into a map 404 until it is directed to stop in block 406.

Referring to FIG. 5, a process for generating a map from landmarks is carried out by the processor 100 shown in FIG. 3. The process in FIG. 5. refers to a single iteration of processing a map and is the description of block 404 shown in FIG. 4. One iteration in the context of this apparatus refers to the processing that occurs using one observation of the landmarks returned by a plurality of landmark sensors.

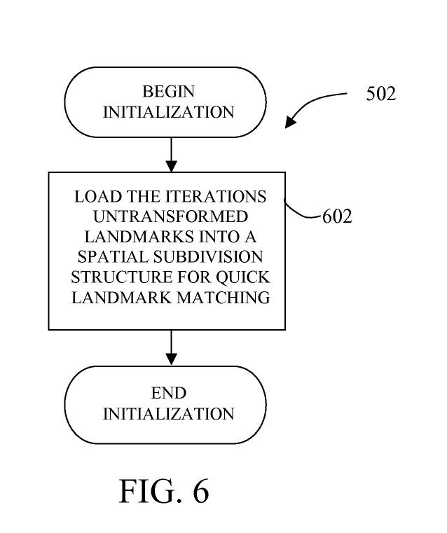

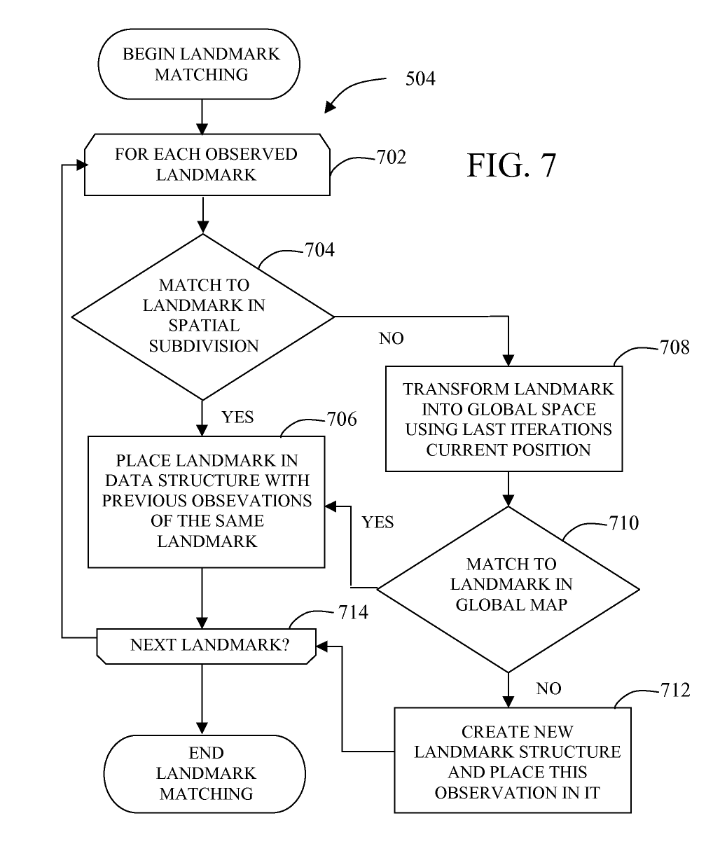

Referring to FIG. 5, a process for generating a map from landmarks begins with an initialization 502. Block 502 is shown in greater detail in FIG. 6. On the completion of the initialization 502, the processor 100 is directed by block 504 to match the current iterations untransformed landmarks to previously seen landmarks. The processor 100 stores untransformed observations of the same landmark together in storage for later processing. Block 504 is shown in greater detail in FIG. 7.

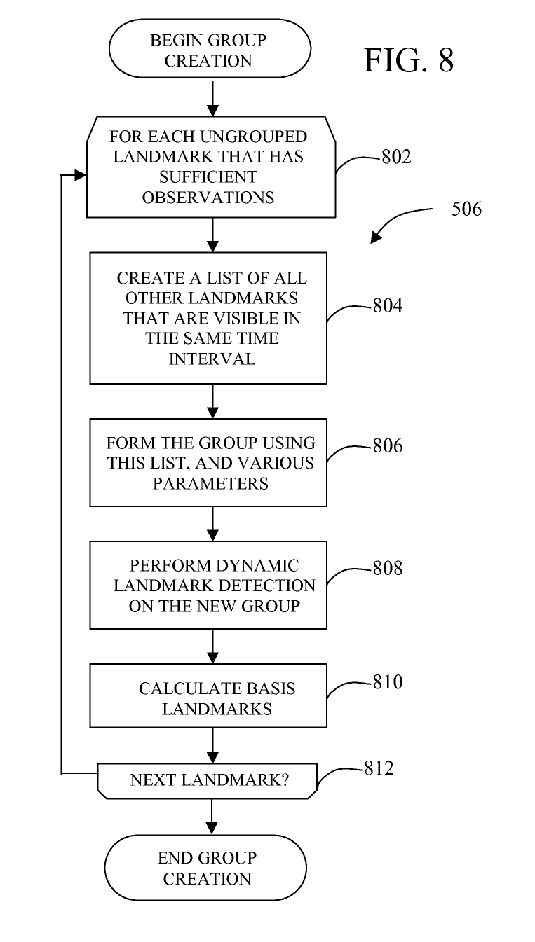

Referring to FIG. 5, block 506 directs the processor 100 to create groups for any ungrouped landmarks. Groups are created with that are visible at the same time interval. Block 506 also directs the processor to perform dynamic landmark detection that identifies landmarks that are not correlated to the movement of the viewpoint of the landmark sensors. Block 506 is shown is greater detail in FIG. 8.

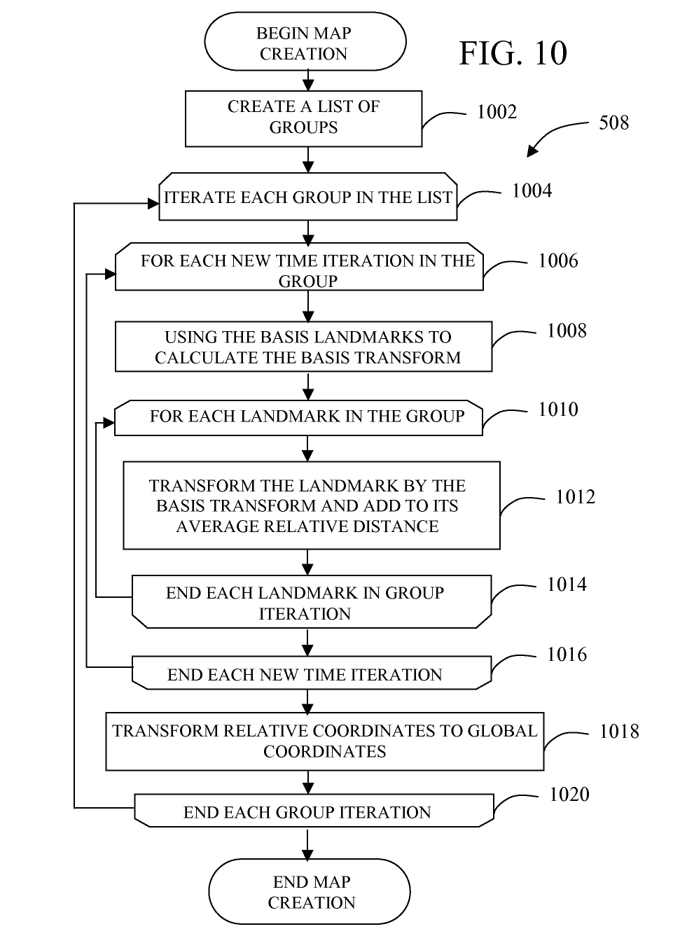

Referring to FIG. 5, block 508 directs the processor to compute a relative map of each group. After each group has its relative map processed they are aligned to a previously mapped group. If the relative group is observed in the first iteration then it is aligned to its first observations. Block 508 is shown in more detail in FIG. 10. In some embodiments it is possible for dynamic detection to also occur in block 508. Also in some embodiments it is possible to use position data from odometery, GPS, closing the loop information, or from other techniques for the alignment. Block 510 directs the processor to calculate the current position. It is calculated by comparing the currently observed untransformed observations of landmarks to their globally mapped positions.

Referring to FIG. 6, the processor is directed to perform the initialization 502 shown in FIG. 5. The initialization consists of creating a spatial subdivision data structure with the past iterations untransformed landmarks. A spatial subdivision data structure subdivides space so only a subdivision of the total amount of landmarks needs to be searched to find its closest match. Examples of a spatial subdivision data structures is an octree and kd-tree.

Referring to FIG. 7, the processor is directed to perform block 504 in FIG. 6. Block 504 registers every landmark received from the sensor from block 402 in FIG. 4. Registration is the common term used in the art that refers to comparing input landmarks to ones that are previous seen. After a positive comparison is made the new landmark data is added to the previous. It is important that all the observations of an individual landmark can be successfully registered. If not, it is likely the map will have errors.

Most other apparatuses in the art use current position to first transform the landmark into global space. Then each landmark is compared to the global map. If current position has an error that is large enough the apparatus can fail. The error is current position can be due to noise from the sensors or incorrect information from dynamic landmarks.

This method and apparatus for generating a map from landmarks differs in the way landmarks are registered. Instead of transforming landmarks they are stored in their untransformed state. The present iterations of landmarks are registered using the last few iterations untransformed landmarks. Using this method, the landmark registration is not dependant on current position. The exceptions are when backtracking, closing the loop and when previous untransformed references of the landmark are not available perhaps due to noise. In these cases current position is used to register the landmarks. However current position only needs to be locally accurate for backtracking to work, which is generally the case. For closing the loop, that is being able to recognize when the viewpoint returned to a starting point, current position is required to be accurate to within a landmarks matching bound, which is the case for other techniques in the art.

Referring to FIG. 7, block 702 directs the processor to register every landmark seen in the current iteration. Block 704 directs the processor to compare a landmark against the last few iterations of previously seen untransformed landmarks. Block 704 uses the spatial subdivision structure created in block 602 in FIG. 6. If block 704 is able to match to a previously seen untransformed landmark it is added to that landmarks data structure in block 706. Then block 714 checks if there are any more untransformed landmarks this iteration. If so the processor is directed to go back to block 704. If not the landmark registration ends.

Referring to FIG. 7, block 708 directs the processor to transform an untransformed landmark into global coordinates using current position. In other embodiments the current position is augmented with knowledge of a predicted current position, or odometry, or GPS, or another method to obtain position data. This occurs when the viewpoint backtracks or closes the loop and previously seen landmarks are observed. It is also a possibility in some embodiments of this invention that block 708 is required due to noise or a landmark not being present in every iteration. The processor is directed to look for a global match in block 710. If one is found, the processor executes block 706 and then executes block 714 as described in the previous paragraph. If the processor cannot find a match then block 712 is executed that creates a new landmark structure. This structure is then added to a new group in block 506 in FIG. 8.

Referring to FIG. 8, block 506 directs the processor to create groups for any landmarks not already in a group. Referring to FIG. 5, group creation in block 506 takes place between the landmark registration in block 504 and map creation in block 508. Referring to FIG. 8, the processor beings by searching for any ungrouped landmarks. In some embodiments this can be an actual search, or in other embodiments there could be a list of ungrouped landmarks that is queried. The processor iterates for each ungrouped landmark in block 802. The processor executes block 804 to create a list of all other landmarks that are visible when the ungrouped landmark is visible. In some embodiments this can be a search and in other embodiments there can be a pre-computed structure that stores landmarks based on the iteration they are visible in for quick retrieval.

Referring to FIG. 8, block 806 directs the processor to find from the list generated in block 804, the best combination of landmarks to form a group with the ungrouped landmarks. The processor can use parameters to determine which landmarks to add. One embodiment can be that the landmark must be visible for a certain percentages of iterations when the ungrouped landmark is visible.

Another embodiment of group creation can start by first sorting the already grouped landmarks from highest to lowest. The landmark that is present in the most iterations of the ungrouped landmark's observation interval is the highest. Then using this sorted list, landmarks are tested from highest to lowest. A test is performed that has the interval of the landmark that is being tested, combined with the interval of the group. The interval of the group at first only contains the observation interval of the ungrouped landmark. If the interval multiplied by the number of landmarks now in the group plus the one being tested exceeds the previous total, the landmark can be placed into the group. Then the next landmark in the list is queried.

The process of adding landmarks to a group is an optimization problem, which there are many potential solutions known in the art. The only requirement of block 806 is that a minimum number of landmarks that are already mapped are in the new group. These previous landmarks are used to transform the group's map from relative to global coordinates. If at any time there are less than the minimum number of previous landmarks the group creation stops and does not attempt to find a group for the ungrouped landmark again.

Referring to FIG. 8, block 806 may occur over the course of the processing one to many times for each landmark. This is due to the fact that it may not be known which landmarks to group together until sufficient iterations have passed by. One embodiment might include only one grouping process. Another embodiment might have one grouping process after a landmark is observed after only a few iterations and then a second after it has been seen for many iterations. The second grouping is considered better and removes the first grouping. A third embodiment might contain numerous groupings until a final grouping is performed after a landmark is no longer visible. This third embodiment is able to use the maximum amount of information to determine the grouping.

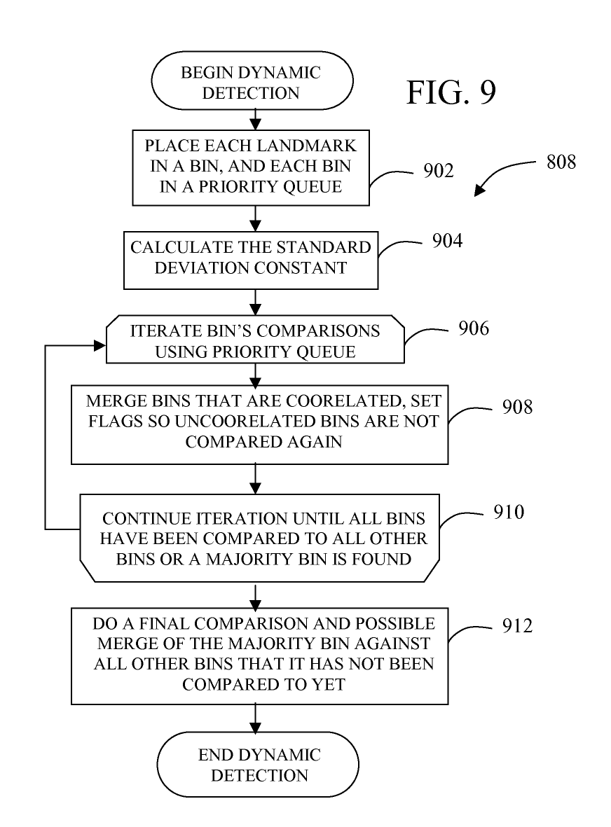

Referring to FIG. 8, block 808 directs the processor to perform dynamic detection on the group. Landmarks are compared against each other to determine which ones are static or dynamic. An example of static landmarks is landmarks that represent walls, while dynamic landmarks represent people that are walking Dynamic detection is shown in greater detail in FIG. 9.

Referring to FIG. 8, block 810 directs the processor to calculate the basis landmark(s) for the relative map calculation that occurs in FIG. 10. Since the relative map requires translation and rotation invariance it is required that one or several of the landmarks be used as the basis of the relative map. It is important that the basis landmarks are chosen to minimize the mapping error.

Referring to FIG. 8, block 812 directs the processor to execute block 506 for each ungrouped landmark by returning to block 802.

Referring to FIG. 9, the processor is directed to perform dynamic landmark detection in a group from block 808 in FIG. 8. The process executes block 808 to find landmarks that are static. Referring to FIG. 9, the processor is directed to place each landmark of the group in its own bin in block 902. A reference to each bin is placed in a priority queue. A priority queue is a data structure that the most important member is in the front and is access first before other less important members. Some embodiments of the priority queue can use the bin size to sort the priories. Other embodiments can use a flag that is set if the bin has had a past positive comparison.

Referring to FIG. 9, block 904 directs the processor to compare each bin against one other bin. The comparison uses the time interval where the landmarks are present. For each iteration in the time interval, the distance between untransformed landmarks for the iteration of each bin is calculated. The distance is saved as running average. A second iteration uses the distance and the average to find the standard deviation. The standard deviation is saved in a list for every bin comparisons. The standard deviation list is sorted from lowest to highest. The sorted list is traversed to determine the threshold that is used to decide if two bins standard deviation is small enough to be considered correlated. In the present embodiment block 904 is integrated with block 906, 908 and 910 for computation efficiency.

Referring to FIG. 9, block 906 directs the processor to iterate the bin comparisons. For each iteration, each bin is compared to only one other bin in block 908. The comparison uses one landmark from each bin and a time interval where the landmarks are both visible. For each iteration in the time interval, the distance between untransformed landmarks in the given iteration from the two landmarks is calculated. The distance is saved towards a running average. A second loop uses the same distance and the average to find the standard deviation. If the standard deviation is less than the threshold calculated in block 904 the two bins are merged. If not, then flags are set so the two bins are never compared to each other again.

Referring to FIG. 9, block 910 directs the processor to continue the comparisons until either all bins have been compared to all other bins, or one bin is found to have the majority of landmarks. Other embodiments might use a threshold less then a majority to stop. Block 912 directs the processor to do one final loop, comparing and possibly merging the majority bin against all other bins it has not been compared to yet.

The processing of block 808 is considerably more efficient than other previous methods. Most other methods require every landmark to be compared against every other landmark. This causes the other methods to be computationally expensive. Using bins approximates the problem by assuming that once many landmarks are placed in one bin they are correlated so only one landmark per bin needs to be compared against another bin. The result of this is that if every landmark is correlated, for n landmarks only O(n−1) comparisons need to occur which is the minimum.

If a high number of landmarks are dynamic only O(n log n) comparisons need to occur. This is due to the use of the priority queue and majority bin detection. The priority queue prioritizes bins that have many landmarks that are correlated. It allows the larger bins to be compared before bins that have few members. The smaller bins are the ones more likely not to be the majority bin. When the majority bin is found the looping can stop. As long as the number of dynamic landmarks is a few percentage points below the threshold for the majority bin it has been shown that only O(n log n) comparisons need to occur.

Referring to FIG. 10, the processor is directed to create a map from block 508 in FIG. 5. The processor uses the group that are created from block 506 in FIG. 8. At this point the processor has already grouped landmarks, determined the basis landmarks for translation and rotation invariance and performed dynamic detection.

Referring to FIG. 10, the processor in block 1002 is directed to create a list of groups that have had a new observation of a landmark in the current iteration. In one embodiment the list is processed by looking at all the groups. In another embodiment the list is more efficiently created by having linking structures. The linking structures are such that when an observation of an untransformed landmark is added to a landmark structure, the landmark structure is able to notify every group it is in to place that group on the group calculation list.

Referring to FIG. 10, the processor in block 1004 iterates each group that may need to be recalculated. Block 1006 directs the processor to iterate the groups processing for each iteration it can be recalculated. There is the potential of more then one iteration if a new group has just been created using many past iterations. Block 1008 directs the processor to calculate the basis transform. This transform allows the relative map to be rotation and translation invariant. After the transform is applied, regardless of the viewpoints movement, the relative location between the landmarks will be approximately the same. The basis is set in 810 in FIG. 8. For example when three dimensional points are used as landmarks, one embodiment of the basis is to use three of those points. Referring to the Cartesian coordinate system, one point would be set being on the origin. The second point would be set to being on the negative x axis. The third point would be set to being on the xz plane. The basis transform matrix is a simple calculation for those of ordinary skill in the art.

In other embodiments the relative map can be calculated using another method. An example is to calculate a relative map of three dimensional objects by combining the average distance between many landmarks rather then use x,y,z coordinates. The method of calculating the relative map is not important. Rather that maps be calculated using the untransformed landmarks without the use current position as much as possible.

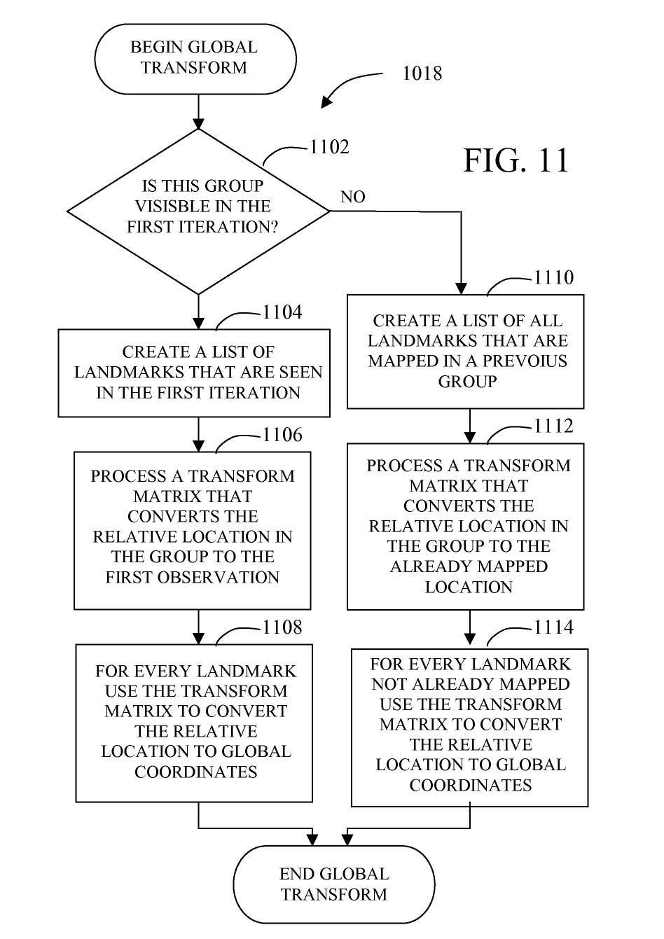

Referring to FIG. 10, block 1010 directs the process to iterate each point in the group. For each point, the untransformed landmark in the iteration determined by block 1006 is obtained from the landmark storage. In block 1012 the untransformed landmark is transformed with the basis matrix. This operation places the landmark into relative coordinates. Its relative coordinates are added to a running average. In block 1014 the iteration over all the landmarks in the group ends and its average relative distance can be calculated by dividing the running average by the number of iterations. Block 1016 ends the loop for each time iteration the relative distance is to be calculated in. Block 1018 directs the processor to process the average relative coordinates into global coordinates. This is described in greater detail in FIG. 11. Block 1020 ends the loop of all the groups.

Referring to FIG. 11, the processor is directed to process the average relative coordinates into global coordinates from block 1018 in FIG. 10. Block 1102 directs the processor to check if the group is created from the first viewed iteration. If it is, the group is the first group created and the processor is directed to process block 1104. If not, when this group is created, it is created with landmarks that have already been mapped in a previous group. The processor is directed to process block 1110 next.

Referring to FIG. 11, block 1104, the processor is directed to place the first group into global coordinates using the first observation of each landmark. Block 1104 directs the processor to create a list using all the landmarks in the group. The list includes the landmarks relative location and the location of their first observations. Block 1106 directs the processor to process a transform matrix that that is able to convert the relative group into global coordinates (first observations) using Least Square Fitting (LSF). The concept of LSF has been extensively described in the literature. See K. S. Arun, et al., Least Square fitting of two 3-D point sets., IEEE transactions on Pattern Analysis and Machine Intelligence, 9(5):698-700, 1987. Block 1108 then directs the processor to calculate the global coordinates for every landmark in the group using the transform matrix calculated by LSF

Referring to FIG. 11, block 1110 directs the processor to place every non first group into global coordinates. When a group is created, it is guaranteed to have a minimum amount of landmarks in it that are already mapped. Block 1110 directs the processor to create a list of these previously mapped landmarks storing both the relative coordinates in the group and their global coordinates. Block 1112 directs the processor to use the relative coordinates and the global coordinates with LSF to create a transform matrix. Block 1114 directs the processor to use the created transform matrix to transform the relative coordinates into global coordinates. Only landmarks that are not mapped by a previous group have their global coordinates calculated.

In other embodiments it is possible to skip block 1018 in FIG. 11. The basis landmarks can be already placed into global coordinates if they are mapped in a previous group. In this case relative coordinates are the same as global coordinates, and block 1018 is not required. In other embodiments the alignment of relative maps to the global map can be augmented with knowledge of position data, such as odometry, GPS. In other embodiments the alignment of relative maps to the global map can be augmented using closing the loop information.

While specific embodiments of the invention have been described and illustrated, such embodiments should be considered illustrative of the invention only and not as limiting the invention as construed in accordance with the accompanying claims.

I claim:

1. A method for generating a map from landmarks, the method comprising:
(a) comparing a current observation of a landmark to stored previously observed untransformed landmarks from past iterations, if there is no match then comparing the landmark by transforming it to global coordinates using current position, comparing the transformed landmark to globally mapped landmarks, and if there is still is no match then adding the landmark as a new entry,
(b) storing the current observation of a landmark with a plurality of past observations of the same landmark that it is matched to for use in later processing,
(c) grouping new landmarks into groups with other landmarks that are visible at the same time interval,
(d) performing dynamic detection to identify dynamic landmarks by using the approximation that landmarks can be placed into bins, and when bins are compared to each other only one landmark is required from each bin for the comparison,
(e) calculating a relative map for each grouping,
(f) linking together the relative maps of all the groups to generate a global map,
(g) calculating current position using the currently seen landmarks compared to their location on the global map.

2. The method claimed in 1 wherein the landmarks consist of three dimensional points.

3. The method claimed in 1 wherein the landmarks consist of planes or surfaces that may be textured.

4. The method claimed in 1 wherein dynamic detection is also performed when calculating the relative map for each group.

5. The method claimed in 1 wherein a mobile platform is used as a platform for a plurality of processors and sensors for generating a map from landmarks, where the map is used for navigation purposes.

6. The method claimed in 1 wherein a stationary platform is used as a platform for a plurality of processors and sensors for generating a map from landmarks, where the map is used to locate and track dynamic objects in the map.

7. The method claimed in 1 wherein dynamic objects are not present and dynamic detection is not required.

8. The method claimed in 1 wherein the map consists of identifying and tracking only dynamic objects.

9. The method claimed in 1, wherein a position sensor or data such as GPS, or a predictive estimate of location, is used in combination with the said method to match landmarks and align the relative map of the groups to the global map.

10. An apparatus for generating a map from landmarks, the apparatus comprising a processor circuit configured to:
(a) comparing a current observation of a landmark to stored previously observed untransformed landmarks from past iterations, if there is no match then comparing the landmark by transforming it to global coordinates using current position, comparing the transformed landmark to globally mapped landmarks, and if there is still is no match then adding the landmark as a new entry,
(b) storing the current observation of a landmark with a plurality of past observations of the same landmark that it is matched to for use in later processing,
(c) grouping new landmarks into groups with other landmarks that are visible at the same time interval,
(d) performing dynamic detection to identify dynamic landmarks by using the approximation that landmarks can be placed into bins, and when bins are compared to each other only one landmark is required from each bin for the comparison,
(e) calculating a relative map for each grouping,
(f) linking together the relative maps of all the groups to generate a global map,
(g) calculating current position using the currently seen observations compared to their location on the global map.

11. The apparatus claimed in 10 wherein said processor circuit is configured to use landmarks consisting of three dimensional points.

12. The apparatus claimed in 10 wherein said processor circuit is configured to use landmarks consisting of planes or surfaces that may be textured.

13. The apparatus claimed in 10 wherein said processor circuit is configured to perform dynamic detection when calculating the relative map for each group.

14. The apparatus claimed in 10 wherein said processor circuit is configured in a platform with a plurality of processors and sensors for generating a map from landmarks, where the map is used for navigation purposes.

15. The apparatus claimed in 10 wherein said processor circuit is configured in a platform with a plurality of processors and sensors for generating a map from landmarks, where the map is used to locate and track dynamic objects in the map.

16. The apparatus claimed in 10 wherein said processor circuit is configured to not perform dynamic detection since dynamic objects are not present.

17. The apparatus claimed in 10 wherein said processor circuit is configured to identify and track only dynamic objects.

18. The apparatus claimed in 10 wherein said processor circuit is configured to use a position sensor or data such as GPS, or a predictive estimate of location, is used in combination with the said apparatus to match landmarks and align the relative map of the groups to the global map.

19. A method for identifying groups of correlated objects through binning, the method comprising:
(a) placing each object into a separate bin,
(b) comparing each bin to every other bin where only one object from each bin is required for the comparison,
(c) merging bins if the comparison is within a threshold,
(d) flagging bins if the comparison is higher than the threshold so they are not compared again,
(e) using a means to prioritize comparisons.

20. The method claimed in 19, wherein a means of ending the comparison loop is used when a desired grouping is achieved.
